(19) United States
(12) Patent Application Publication
(10) Pub. No.: US 2021/0073896 A1
(43) Pub. Date: Mar. 11, 2021

(54) PRODUCT ORDER PREDICTION METHOD

(71) Applicants: INVENTEC (PUDONG) TECHNOLOGY CORPORATION, Shanghai City (CN); INVENTEC CORPORATION, Taipei City (TW)

(72) Inventors: Jonathan Hans SOESENO, Taipei City (TW); Trista Pei-Chun CHEN, Taipei City (TW); Chih Hung HUANG, Taipei City (TW); Junh Hsien TU, Taipei City (TW); Wei-Chao CHEN, Taipei City (TW); Chao-Nan CHEN, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 16/718,795

(22) Filed: Dec. 18, 2019

(30) Foreign Application Priority Data
Sep. 11, 2019 (CN) 201910860261.3

(51) Int. Cl. G06Q 30/06; G06N 3/08

(52) U.S. Cl. CPC G06Q 30/0635; G06N 3/08

(57) ABSTRACT

A product order prediction method adapts to a production planning system. The method comprises obtaining a reference data related to a next reference order and a current actual order, performing an algorithm based on the neural network model according to the reference data and the current actual order to generate a feature vector, and performing another algorithm based on the neural network model according to the feature vector to output a next predicted order to the production planning system, for the production planning system to generate an operation plan of a production line of the product according to the next predicted order.

### CROSS-REFERENCE TO RELATED APPLICATIONS

This non-provisional application claims priority under 35 U.S.C. § 119(a) on Patent Application No(s). 201910860261.3 filed in China on Sep. 11, 2019, the entire contents of which are hereby incorporated by reference.

### BACKGROUND

### 1. Technical Field

The present disclosure relates to a product order prediction method, and more particularly to a product order prediction method using a model trained by the neural network.

### 2. Related Art

For electronic product manufacturers, the optimal situation is that the inventory is kept below a certain amount. Excessive inventory and low turnover rate of inventory will consume a large number of funds and generate a burden on the cash flow. In addition, excessive inventory also increases additional time and labor costs for warehousing costs, product picking and inventory taking.

Today's methods for product order prediction are mostly based on experience, previous orders, and inventory data. However, human beings cannot accurately handle complex data with high dimensional. Even if the product order prediction adopts a simple regression or a time series analysis, these kinds of methods can only predict according to the previous case, and they cannot analyze from a long-term perspective to ensure its accuracy of prediction. Therefore, there is a great need for the product order prediction method with high accuracy.

### SUMMARY

According to one or more embodiment of this disclosure, a product order prediction method adapted to a production planning system comprising: obtaining a reference data of a next reference order related to a product and a current actual order of the product; performing an algorithm according to the reference data and the current actual order to generate a feature vector, with said algorithm based on a neural network model; and performing another algorithm according to the feature vector to output a next predicted order to the production planning system, for the production planning system to generate an operation plan of a production line of the product according to the next predicted order.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flowchart of the product order prediction method according to an embodiment of the present disclosure; and

FIG. 2 is a line chart of “order quantity-time” showing a next predicted order, a next reference order, and current actual order.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The product order prediction method proposed by the present disclosure is adapted to a production planning system. The production planning system, such as a cloud server, may be used to control the operation of the product line. The production planning system may comprise a processor and a memory, and may further comprise a hard disk and a plurality of arithmetic units computing in parallel. The processor of the production planning system performs the product order prediction method proposed by the present disclosure. The production planning system adaptively adjusts the operating parameters of the machines on the production line according to the output result of the product order prediction method proposed in the present disclosure, thereby improving or reducing the production cycle to control the product output. In practice, the production planning system is, for example, an ERP (Enterprise Resource Planning), or a PSI (Purchase, Sales, Inventory) management system.

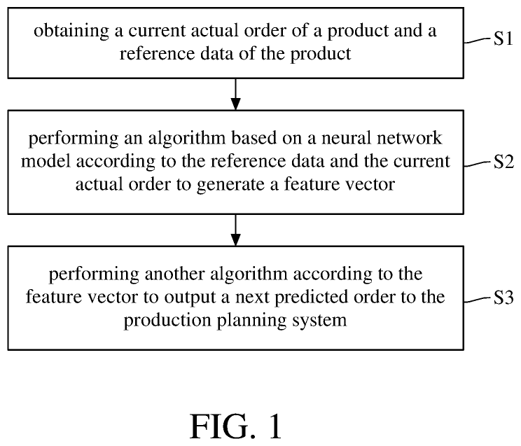

Please refer to FIG. 1, which illustrates a flowchart of a product order prediction method according to an embodiment of the present disclosure.

Please refer to step S1, “obtaining a current actual order of a product and a reference data of the product”.

Specifically, the current actual order is, for example, one or more values recorded in a SO (Sales Order). The reference data is related to the next reference order of the product. The reference data comprises one or more reference values. If the reference data has one reference value, said one reference value is the next reference order. If the reference data comprises a plurality of reference values, the plurality of reference values corresponds to a plurality of reference orders, one of the plurality of reference orders is the next reference order, and said reference orders are periodic with a first period. The first period is such as “a week”, and the reference data may be the reference order of next week as well as the subsequent reference orders of next (N−1) weeks. (It means that the reference data comprises reference orders of consecutive N weeks.) The reference data may further comprise target inventory rates of the next N weeks, the predicted prices of the raw material of the next N periods, the weather of next N weeks, or a combination of the above. The present disclosure does not limit the value of N nor the type and quantity of the reference data.

Please refer to step S2, “performing an algorithm according to the reference data and the current actual order to generate a feature vector, with said algorithm based on a neural network model”. In an embodiment of the present disclosure, the neural network model on which the algorithm based is, for example, the LSTM (Long Short Term Memory) including attention mechanism. The input parameters of LSTM are multi-dimensional vectors (such as N+1 dimensions) including reference data (such as reference orders of consecutive N weeks) and current actual order (such as the amount of order accumulated from the last Sunday to this Saturday). The neural network model adopting LSTM uses the multi-dimensional vectors (the dimension degree is such as 30) as parameters of the input layer, and outputs a multi-dimensional feature vector (the dimension degree is such as 64).

Practically, the neural network model adopting LSTM is trained with the past reference data and the past actual order beforehand. For example, the training phase takes the reference order and the actual order from the 1^{st} week to the 20^{th} week to automatically adjust a plurality of weights in the neural network model, the trained model will be used in the production planning system and production line at the 21^{st} week, and the predicted order generated from the 21^{st} week and the actual order received from the 21^{st} week can be selectively fed back to the neural network model. In addition, the reference data may be inputted to the neural network model using LSTM with different periods. For example, the reference order as one input layer parameter is inputted every “week”, and the raw material prediction price as another input layer parameter is inputted every “month”. When updating the input layer parameters of the reference order every week, if it is not the time point for updating the raw material prediction price, zero value or the previous input value can be optionally entered.

Please refer to step S3, “performing another algorithm according to the feature vector to output a next predicted order to the production planning system”, for the production planning system to generate an operation plan of a production line of the product according to the next predicted order. Said another algorithm is the algorithm based on a neural network model or the algorithm based on a regression analysis. In practice, the neural network model on which the algorithm based is MLP (Multilayer perceptron). MLP uses the multi-dimensional feature vector generated by LSTM as the input parameters, and uses a linear combination to convert the feature vector into a scalar number, this scalar number represents the next predicted order. Therefore, the control system of the production line may adaptively adjust the production progress in the production line according to the number of next predicted order and prevents the increase of inventory rate. In another embodiment of the present disclosure, MLP may output a plurality of scalar numbers serving as a number of consecutive predicted orders. For example, if the number is 4, four predicted orders for four consecutive weeks are outputted, there is a predicted interval between any two consecutive predicted orders, and these four predicted orders are served as reference indicators of the production planning system for the next month. The production machine on the production line can also determine the parameter settings of their own according to the next predicted order.

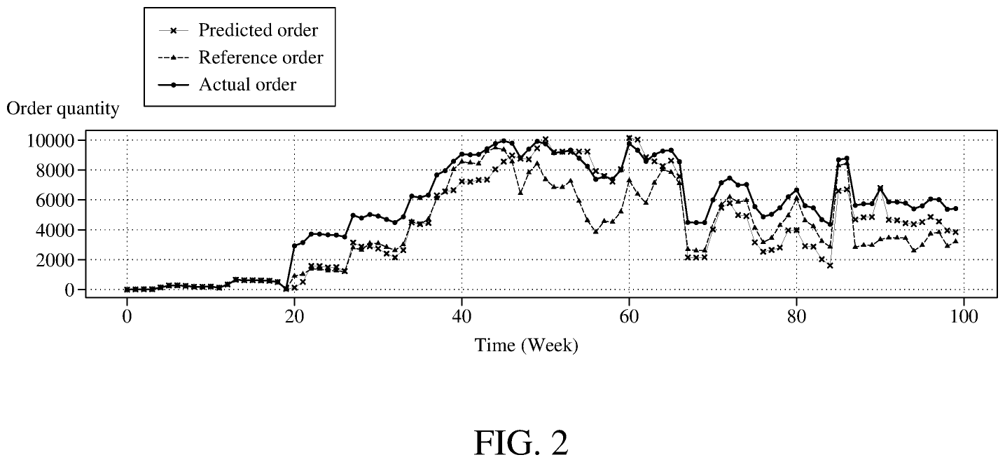

Please refer to FIG. 2, which illustrates a line chart of “order quantity-time” of the next predicted order, next reference order, and current actual order obtained by performing the product order prediction method according to an embodiment of the present disclosure, wherein the first 20 weeks are the training phase of the neural network model, so the actual order, the predicted order, and the reference order have the same value. The neural network model is in the online operation phase since the 21^{st} week. As shown in FIG. 2, the predicted order obtained by performing the product order prediction method according to an embodiment of the present disclosure becomes closer to the actual order after about the 50^{th} week, and this represents the accuracy of the product order prediction method according to an embodiment of the present disclosure may be improved during the running time of the online operation.

In view of the above, the product prediction method proposed in the present disclosure adopts LSTM and MLP to serve as a weighting unit and an analysis unit respectively. LSTM outputs multi-dimensional vectors serving as the input of MLP, and MLP outputs a one-dimensional (or multi-dimensional) vector serving as the next predicted order. The input data of LSTM includes the current actual order and the reference data. The reference data comprises various types of prediction information, such as reference orders for half a year or predicted inventory rates. The product order prediction method of the present disclosure may automatically adjust the weight value in the weighting unit during the training phase, the actual operation result and the error are served as the new training data and can be fed back to the neural network model, and the accuracy may be further improved during the online operation. Overall, the production order prediction method disclosed in the present disclosure can comprehensively consider various types of information associated with the order and predict the next order accurately. For example, if the prediction result expects to receive a large number of orders next week, the production line may actively increase the production capacity in this week to meet next week's orders. On the other hand, if the prediction result shows that the number of orders will decrease next week and this may lead to an increase in inventory rate, the production line may reduce production capacity this week to avoid overproduction. The present disclosure helps to reduce inventory and further reduce the time cost and labor cost of inventory storage.

What is claimed is:

1. A product order prediction method adapted to a production planning system comprising:
obtaining a reference data of a next reference order related to a product and a current actual order of the product;
performing an algorithm according to the reference data and the current actual order to generate a feature vector, with said algorithm based on a neural network model; and
performing another algorithm according to the feature vector to output a next predicted order to the production planning system, for the production planning system to generate an operation plan of a production line of the product according to the next predicted order.

2. The product order prediction method of claim 1, wherein the neural network model is Long Short Term Memory network.

3. The product order prediction method of claim 1, wherein said another algorithm is an algorithm based on another neural network model or an algorithm based on a regression analysis.

4. The product order prediction method of claim 3, wherein said another neural network model is Multilayer Perceptron.

5. The product order prediction method of claim 1, wherein the reference data comprises a plurality of reference values, the plurality of reference values corresponds to a plurality of reference orders, said reference orders are periodic with a first period, and one of the plurality of reference orders is the next reference order.

6. The product order prediction method of claim 1, wherein said another algorithm further outputs another next predicted order, and there is a predicted interval between the two next predicted orders.
